(19) United States
(12) Patent Application Publication
(10) Pub. No.: US 2026/0119000 A1
(43) Pub. Date: Apr. 30, 2026

(54) CONTENT DELIVERY OF CONTEXTUAL INFORMATION VIA USER INTERFACE ELEMENTS

(71) Applicant: Capital One Services, LLC, McLean, VA (US)

(72) Inventors: Bryan TAMAYO, Allen, TX (US); William MERKEL, Garland, TX (US)

(21) Appl. No.: 18/933,306

(22) Filed: Oct. 31, 2024

(51) Int. Cl. G06F 3/0481; G06F 3/04855

(52) U.S. Cl. CPC G06F 3/0481; G06F 3/04855

(57) ABSTRACT

In some implementations, a device may receive a web page that includes code, and includes content organized in a plurality of content modules associated with the web page. The device may render the web page for presentation in a user interface. The device may monitor interaction data relating to a use of a user interface element. The device may identify in accordance with the interaction data, a content module, of the plurality of content modules, aligned with the user interface element. The device may select, responsive to identification of the content module, a user interface element widget. The device may render the user interface element widget on the web page. The device may provide an updated version of the web page with the user interface element widget.

### BACKGROUND

User interface element widgets may include interactive elements provided within software applications. User interface element widgets may include buttons, sliders, text fields, or checkboxes, among other examples. A software application may integrate widgets into graphical user interfaces (GUIs) to enhance usability and provide intuitive interactions. For example, users may manipulate user interface element widgets to input data, trigger events, or navigate through applications. Backend processes support widgets by managing data flow and responding to user inputs. When a user interacts with a widget, a system may execute corresponding code to process the input and update a display.

### SUMMARY

Some implementations described herein relate to a system for providing contextual information via a user interface element. The system may include one or more memories and one or more processors communicatively coupled to the one or more memories. The one or more processors may be configured to receive a web page that includes code, and includes content organized in a plurality of content modules associated with the web page. The one or more processors may be configured to render, in connection with an initial page load, the web page for presentation in a user interface, wherein the user interface includes a user interface element associated with navigation of the web page. The one or more processors may be configured to monitor interaction data relating to a use of the user interface element, wherein the interaction data relates to a scrolling behavior, wherein the interaction data relates to a position of the user interface element relative to the plurality of content modules. The one or more processors may be configured to identify, in accordance with the interaction data, a content module, of the plurality of content modules, aligned with the user interface element. The one or more processors may be configured to generate, responsive to identification of the content module, contextual information for the user interface element. The one or more processors may be configured to render the contextual information in connection with the user interface element, such that the user interface element is transformed from an initial version of the user interface element to a target version of the user interface element. The one or more processors may be configured to provide the target version of the user interface element with the web page.

Some implementations described herein relate to a method. The method may include receiving, by a device, a web page that includes code, and includes content organized in a plurality of content modules associated with the web page. The method may include rendering, by the device and in connection with an initial page load, the web page for presentation in a user interface, wherein the user interface includes a user interface element associated with navigation of the web page. The method may include monitoring, by the device, interaction data relating to a use of the user interface element, wherein the interaction data relates to a scrolling behavior, wherein the interaction data relates to a position of the user interface element relative to the plurality of content modules. The method may include identifying, by the device, in accordance with the interaction data, a content module, of the plurality of content modules, aligned with the user interface element. The method may include selecting, by the device and responsive to identification of the content module, a user interface element widget. The method may include rendering, by the device, the user interface element widget on the web page. The method may include providing, by the device, an updated version of the web page with the user interface element widget.

Some implementations described herein relate to a non-transitory computer-readable medium that stores a set of instructions. The set of instructions, when executed by one or more processors of a system, may cause the system to receive a web page that includes code, and includes content organized in a plurality of content modules associated with the web page. The set of instructions, when executed by one or more processors of the system, may cause the system to render, in connection with an initial page load, the web page for presentation in a user interface, wherein the user interface includes a scroll bar associated with navigation of the web page. The set of instructions, when executed by one or more processors of the system, may cause the system to monitor interaction data relating to a use of the scroll bar, wherein the interaction data relates to a position of the scroll bar relative to the plurality of content modules. The set of instructions, when executed by one or more processors of the system, may cause the system to identify, in accordance with the interaction data, a content module, of the plurality of content modules, aligned with the scroll bar. The set of instructions, when executed by one or more processors of the system, may cause the system to insert, responsive to identification of the content module, contextual information from the content module into a scroll bar widget provided at least partially within the scroll bar. The set of instructions, when executed by one or more processors of the system, may cause the system to provide an updated version of the web page with the contextual information inserted into the scroll bar widget.

### BRIEF DESCRIPTION OF THE DRAWINGS

FIGS. 1A-1D are diagrams of an example implementation associated with content delivery of contextual information via user interface elements, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with content delivery of contextual information via user interface elements, in accordance with some embodiments of the present disclosure.

FIG. 4 is a flowchart of an example process associated with content delivery of contextual information via user interface elements, in accordance with some embodiments of the present disclosure.

### DETAILED DESCRIPTION

The following detailed description of example implementations refers to the accompanying drawings. The same reference numbers in different drawings may identify the same or similar elements.

Applications may provide user interfaces that user devices may provide for display to users so that the users can use the applications. For example, a user interface of a web browser provides a framework for users to use the web browser to navigate the internet. A user interface may include various elements, such as an address bar, a set of navigation buttons, or a scroll bar, among other examples. The scroll bar enables users to move vertically or horizontally through content of a webpage that is larger than a display in which the webpage is being provided. Users interact with a scroll bar by clicking and dragging the scroll thumb, clicking on the scroll bar buttons, or by clicking on the scroll track, among other examples. The scroll thumb may refer to a portion of a scroll bar that represents a current position of a webpage that is being provided by display, which may be referred to as a “viewport” of the scrollbar. A web browser application may update the viewport based on a position of the scroll bar (e.g., a position of the scroll thumb within the scroll bar), displaying corresponding content. The application may track the position of the scroll bar and determine which content to render. The user interface may respond to user actions in real-time, thereby providing a fluid browsing experience.

A rendering of a scroll bar may change dynamically based on an amount of content. For example, a size of the scroll thumb within the scroll track may increase when an amount of scrolling for a web page is relatively small and may decrease when an amount of scrolling for a web page is relatively large. Such a dynamic change to the scroll bar may improve usability of the scroll bar by providing different levels of scrolling granularity to users. By providing different levels of scrolling granularity, an application may avoid scenarios where a user has difficulty locating desired information within a web page, which may result in excessive scrolling by the user to locate the desired information. This excessive scrolling may result in an excessive usage of processing resources. Additionally, once a user locates desired information within a web page, which may be referred to as “primary information,” the user may navigate to other web pages to obtain contextual information or secondary information, relating to the desired information. For example, when a user scrolls to a portion of an email message with primary information, such as a set of times for a meeting, the user may open another web page to access contextual information, such as a calendar. As another example, when a user scrolls to a portion of a web page showing an automobile or home for sale (the primary information), the user may open another web page to access information relating to financing for the automobile or home (the contextual information). As some other examples, a user may view job postings as primary information and seek out a resume template or cover letter example as contextual information, the user may view a recipe as primary information and access a conversion calculator as contextual information, or the user may view a project management tool as primary information and may view a communication platform relating to project tasks as contextual information, among other examples.

Some implementations described herein provide for content delivery of contextual information via user interface elements. For example, a user interface, of a web page providing primary information, may be rendered with a user interface element widget providing contextual information that is selected based on the primary information. In this case, a scroll bar of a web page may include one or more widgets, which are selected based on a content of the web page and/or a viewport thereof, and which are provided for display to the user. A user device may automatically include contextual information extracted from the primary information, such as extracting values from the primary information and inserting the values into the user interface element widget. As one example, when a user scrolls an email message to a viewport including a set of times for a meeting, a user device may render a user interface element widget with a calendar set to show a user's availability at the set of times for the meeting. As another example, when a user scrolls a web page to a viewport including an automobile for sale, the user device may render a user interface element widget with a financing calculator filled in with values for the specific automobile for sale in the viewport. As another example, when a user aligns a scroll bar to an ingredient in a recipe, the user device may automatically render a user interface element widget with an ingredient conversion calculator filled in with the amount of the ingredient in the recipe.

By providing user interface element widgets that are linked to a user interface element (e.g., a scroll bar), the user device automatically provides contextual information specific to a portion of a web page that a user is viewing. In this way, the user device may reduce a quantity of browser tabs that the user opens (e.g., to obtain the contextual information), thereby reducing processing resources used by the user.

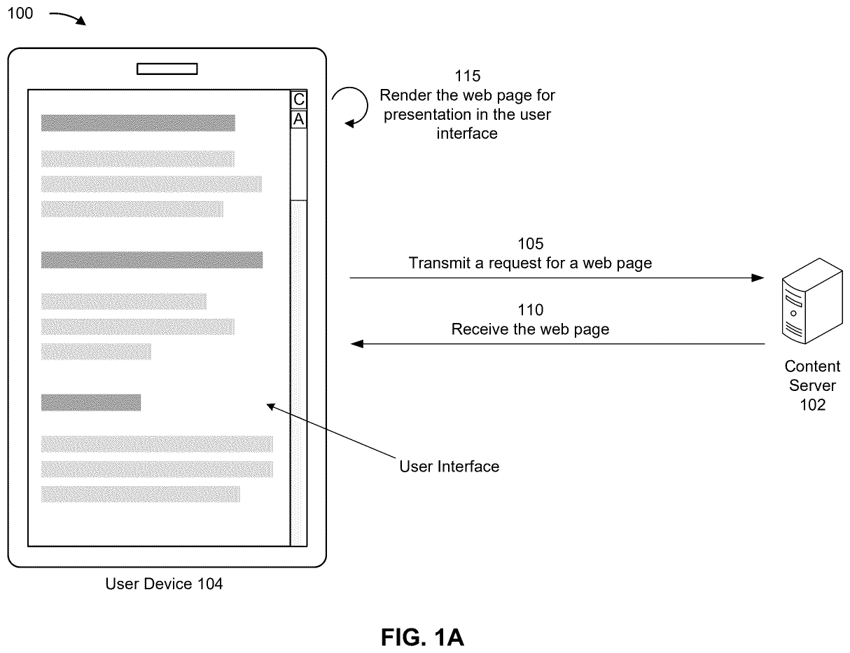

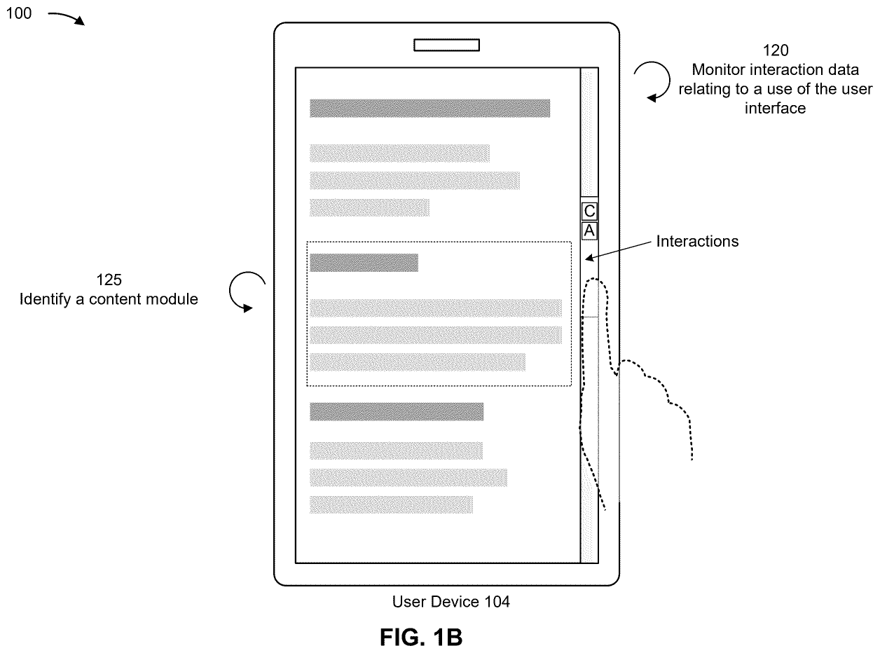

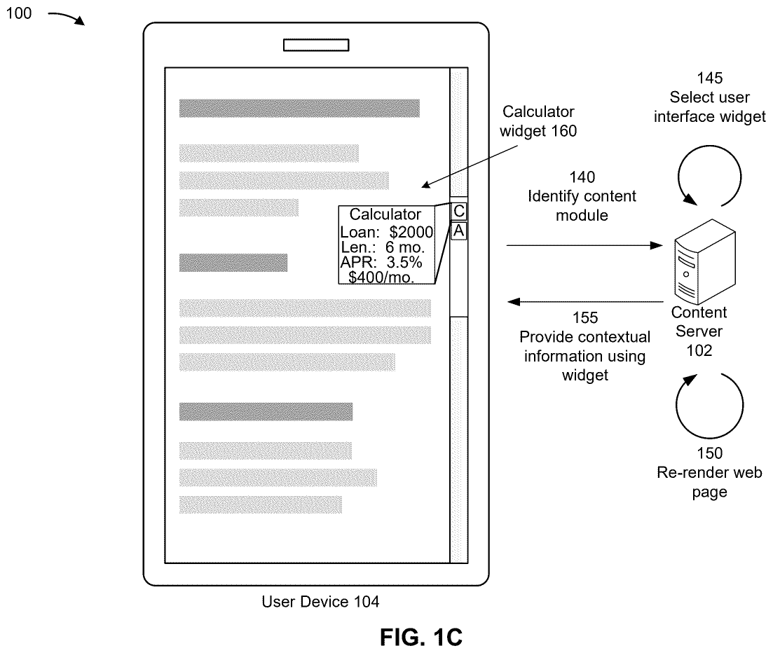

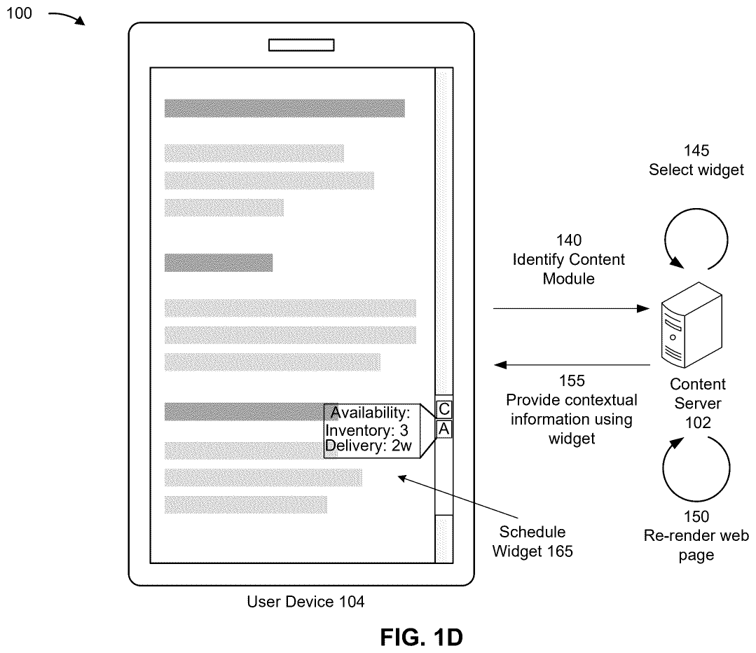

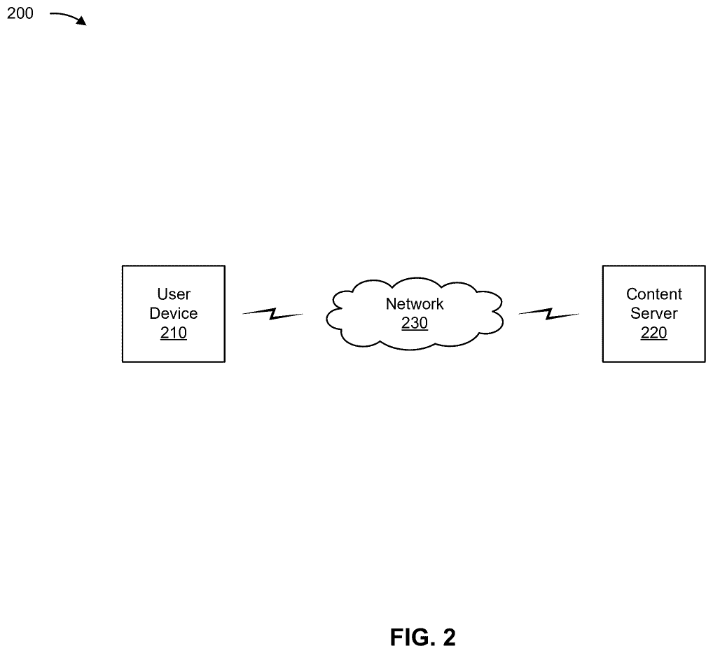

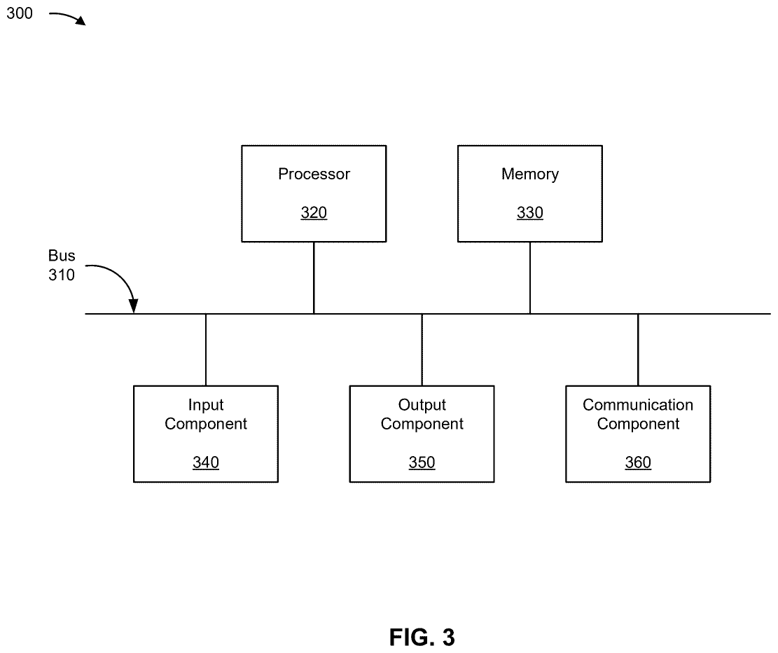

FIGS. 1A-1D are diagrams of an example implementation 100 associated with content delivery of contextual information via user interface elements. As shown in FIGS. 1A-1D, example implementation 100 includes a user device 104 and a content server 102. These devices are described in more detail below in connection with FIG. 2 and FIG. 3.

As further shown in FIG. 1A, and by reference number 105, the user device 104 may transmit a request for a web page. For example, the user device 104 may transmit a request that the content server 102 provide a web page for display. Although some implementations are described herein in terms of a web page, it is contemplated that other types of user interfaces or applications may be possible. In some implementations, the user device 104 may transmit a request that the content server 102 provide primary information for display. For example, the user device 104 may transmit a request for information that identifies a set of dates, items for sale (e.g., automobiles or homes), job postings, recipes, news articles, travel options (e.g., flight options or train options), financial data (e.g., stock market quotes), education information (e.g., an online learning course), health information (e.g., a health article), fitness information (e.g., a fitness tracking dashboard), or project management information (e.g., a project management dashboard).

As further shown in FIG. 1A, and by reference numbers 110 and 115, the user device 104 may receive the web page for display and may render the web page for presentation in the user interface. For example, the user device 104 may receive a response from the content server 102 that provides a web page for display. In some implementations, the user device 104 may receive a response that identifies a set of user interface element widgets. For example, the user device 104 may receive information identifying a set of user interface element widgets to provide for display via a user interface, such as a calendar widget, a calculator widget, a conversion widget, a weather widget, a news widget, a forum widget, an availability widget, a guideline widget, a video widget, or a communication widget, among other examples.

In some implementations, the user device 104 may generate a set of representations of a subset of widgets for rendering in connection with a user interface element of a user interface. For example, the user device 104 may render a set of icons within a scroll bar of a user interface of a web browser that is being used to display the web page. In this case, the user device 104 may select the subset of widgets for rendering based on information included in the web page and/or available contextual information associated therewith. For example, the user device 104 may parse a code of the web page to identify a content of the web page. The content may be organized into a set of content modules. For example, when a web page lists a set of automobiles for sale (e.g., the content), each individual automobile may correspond to a content module (e.g., that includes code for rendering an image of the automobile, a price of the automobile, or a set of features or attributes of the automobile). Similarly, when a web page lists a set of appointments that a user can select (e.g., the content), each individual appointment (or each grouping of appointments by day, time, or person) may correspond to a content module. Similarly, when a web page lists a recipe (e.g., the content), each individual ingredient or each individual recipe step may correspond to a content module. The user device 104 may select a user interface element widget that corresponds to a type of information in the set of content modules. For example, the user device 104 may determine that a financing calculator widget, a reviews widget, and a test drive calendar availability widget are to be provided when a web page lists automobiles for sale.

In some implementations, the user device 104 may determine which widgets to provide using a rule set. For example, the user device 104 may be configured with a rule set mapping a set of types of web pages to a set of groups of widgets. Additionally, or alternatively, the web page may identify which widgets to provide. For example, the web page may include a parameter value in code thereof that the user device 104 may parse and use to select which widgets to provide. Additionally, or alternatively, the user device 104 may use a machine learning or artificial intelligence technique to select one or more widgets to provide. For example, the user device 104 may use a prompt (e.g., which may correspond to the content of the web page or a subset thereof) provided into a large language model (LLM) to request a recommendation of which widgets are to be selected given the content of the web page.

As further shown in FIG. 1B, and by reference number 120, the user device 104 may monitor interaction data relating to a use of a user interface. For example, the user device 104 may monitor one or more inputs to the user device 104 to detect an interaction with a user interface element of the user interface. In this case, the user device 104 may detect a user interaction, such as a scrolling behavior, with a scroll bar of the user interface. For example, the user device 104 may detect a user moving the scroll bar of the user interface to scroll a web page from a first position to a second position. In some implementations, the user device 104 may monitor and/or capture interaction data. For example, the user device 104 may capture interaction data identifying a position of a scroll bar, a movement of the scroll bar, an amount of time spent at a particular position within a web page, or another type of interaction data. In some implementations, the user device 104 may capture relative interaction data. For example, the user device 104 may capture interaction data identifying a relative position of a user interface element and a set of content modules. For example, the user device 104 may determine a position of a scroll bar relative to the set of content modules. In this case, the user device 104 may identify a content module aligned to the scroll bar or a content module predicted to be aligned to the scroll bar within a configured period of time. For example, when a user is engaging in a scrolling behavior, the user device 104 may predict whether the user will scroll to a particular content module based on interaction data (e.g., a current position of the scroll bar or a speed with which the scroll bar is being moved).

As further shown in FIG. 1B, and by reference number 125, the user device 104 may identify a content module. For example, the user device 104 may identify a content module for which to provide contextual information. In some implementations, the user device 104 may identify a content module based on the content module aligning with a user interface element. For example, when a scroll bar of the user interface aligned with a particular content module, of a set of content modules, the user device 104 may determine to provide contextual information for the particular content module. Additionally, or alternatively, the user device 104 may predict that a particular content module will be aligned to the scroll bar within a threshold period of time and may pre-load contextual information in advance of the scroll bar aligning to the particular content module.

As further shown in FIG. 1C, and by reference number 140, the user device 104 may provide information identifying the content module to a content server. For example, the user device 104 may indicate a content module for which the user device 104 is requesting contextual information to provide via a widget. In some implementations, the user device 104 may request that the content server 102 select and provide a widget in a re-rendered web page. In some implementations, rather than offloading web page rendering to the content server 102, the user device 104 may select a user interface element widget, generate contextual information for the user interface element widget, and re-render the web page to provide the user interface element widget.

As further shown in FIG. 1C, and by reference numbers 145 and 150, the user device 104 may communicate with the content server 102 to select a user interface element widget and re-render a web page to include the user interface element widget. For example, the user device 104 and/or the content server 102 may analyze the content module for which a user interface element widget is to be provided. In some implementations, the user device 104 and/or the content server 102 may select a particular widget to provide for display (or a set of widgets to provide for display). For example, the user device 104 may analyze a type or a content of the content module and may identify one or more corresponding user interface element widgets. Based on a user selection of a particular user interface element widget being provided for display, the user device 104 and/or the content server 102 may provide the particular user interface element widget.

In some implementations, the user device 104 may generate contextual information based on or responsive to identifying a content module aligned to a scroll bar. For example, when the user device 104 determines that the scroll bar is aligned to a content module within a web page, the user device 104 may be triggered to select a user interface element widget, extract content information from the content module, and automatically insert the extracted content information or a portion thereof as contextual information into the user interface element widget. In some implementations, the user device 104 may re-render the user interface element widget from an initial version of the user interface element widget to a target version of the user interface element widget. For example, the user device 104 may change a rendering from an icon representing the user interface element widget to a rendering of the user interface element widget with contextual information included therein. In this case, the user device 104 may provide the target version of the user interface element widget (e.g., which includes the contextual information) for display via a web page, as described below.

As shown in FIG. 1C, and by reference numbers 155 and 160, the user device 104 may provide a calculator widget with contextual information. For example, the user device 104 may provide the calculator widget and may insert contextual information into the calculator widget for the user. As shown, a first or initial version of the calculator widget may appear as an icon (e.g., a box with a letter “C” therein) and a second or target version of the calculator widget may appear as a box with contextual information (e.g., values and calculations) therein. In this case, the contextual information may be extracted from the content module that is within a viewport of the scroll bar or a focus capture window associated with the scroll bar. The view port of the scroll bar may include an entirety of a web page that is provided for display at a given position of the scroll bar. In context, the focus capture window may refer to a narrower portion of the web page that is aligned to the scroll bar itself. In other words, the focus capture window may be one or more content modules of a set of content modules being provided for display within a viewport, and the set of content modules within the viewport may be a subset of content modules of the web page. For example, the contextual information may include specific loan information relating to a specific vehicle that is aligned to the scroll bar. In this case, as the scroll bar moves, the user device 104 may dynamically and automatically alter the values within the calculator widget to pre-fill the values for the user. In this way, the user device 104 may obviate a need for a user to open additional web page tabs to identify a loan calculator, thereby reducing a utilization of processing resources.

In some implementations, the user device 104 may automatically obtain contextual information from sources external to the web page being provided for display. For example, the user device 104 may obtain a price of an automobile from within the content module in the web page, but may obtain a current average loan annual percentage rate (APR) from a source external to the content module and/or the web page (e.g., from another web page). By obtaining the APR information from the external source, the user device 104 obviates a need to render a web page of the external source (e.g., for a user to view the APR information for entering into a calculator), thereby reducing a utilization of processing resources. In another example, as shown in FIG. 1D, and by reference number 155 and 165, the user device 104 may provide an alert widget for a content module relating to a manufacturing inventory system. For example, the user device 104 may extract contextual information identifying an inventor for a part that is being displayed on the web page in alignment with the scroll bar. Additionally, or alternatively, the user device 104 may access an external source that includes delivery information to estimate an amount of time to deliver the part to a location of the user device 104. In this way, the user device 104 obviates a need for the user to navigate through multiple web pages to determine the inventory and delivery information. Additionally, or alternatively, by rendering information such as the inventory on-demand when a scroll bar is aligned to a content module, the user device 104 avoids rendering information that is not viewed by the user (e.g., for other parts that are on the web page but are not within the viewport of the scroll bar). In this way, the user device 104 reduces an amount of data that is to be conveyed and rendered, which may reduce a utilization of network resources and/or processing resources. In another example, the user device 104 may provide an analytics display widget that may provide analytics in real-time based on user interactions (e.g., a user for whom the analytics display widget is provided or other users). In other words, an owner of a web page may have a provided user interface element widget identifying other user's interactions with content modules of the web page, thereby alerting the owner to usage of the web page and/or portions thereof. In another example, the user device 104 may provide a messaging widget that may provide real-time notifications to the user (e.g., from other users or from an artificial intelligence assistant, such as a chatbot or LLM assistant).

In some implementations, contextual information and/or user interface element widgets associated therewith may be based on a user preference. For example, the user device 104 may capture one or more user preferences and/or interactions in real time and store the user preferences and/or interactions in a user preference database. In this case, a user preference may include whether a user interacted with a user interface element widget, data that a user entered into a user interface element widget, a type of user of a web page, a location of the user, or another type of user information. Such user preferences and user information may be stored using one or more encryption techniques or libraries to provide for user privacy and information security and/or to ensure compliance with one or more data privacy requirements. The user device 104 may use a database (e.g., a structured query language (SQL) database) that is dynamically updated based on user interactions to support real-time personalization of analytics or recommendations that are provided via a user interface element widget. In some implementations, the user device 104 may have a backend integration module that uses application program interface (API) calls (e.g., RESTful API calls) to exchange data with and obtain information from the content server 102.

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a user device 210, a content server 220, and a network 230. Devices of environment 200 may interconnect via wired connections, wireless connections, or a combination of wired and wireless connections.

The user device 210 may include one or more devices capable of receiving, generating, storing, processing, and/or providing information associated with user interface element widgets within a user interface element, as described elsewhere herein. The user device 210 may include a communication device and/or a computing device. For example, the user device 210 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. In some implementations, the user device 210 may correspond to the user device 104, described in connection with FIGS. 1A-1D.

The content server 220 may include one or more devices capable of receiving, generating, storing, processing, providing, and/or routing information associated with a web page, as described elsewhere herein. The content server 220 may include a communication device and/or a computing device. For example, the content server 220 may include a server, such as an application server, a client server, a web server, a database server, a host server, a proxy server, a virtual server (e.g., executing on computing hardware), or a server in a cloud computing system. In some implementations, the content server 220 may include computing hardware used in a cloud computing environment. In some implementations, the content server 220 may correspond to the content server 102, described in connection with FIGS. 1A-1D.

The network 230 may include one or more wired and/or wireless networks. For example, the network 230 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 230 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with content delivery of contextual information via user interface elements. The device 300 may correspond to user device 210 and/or content server 220. In some implementations, user device 210 and/or content server 220 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

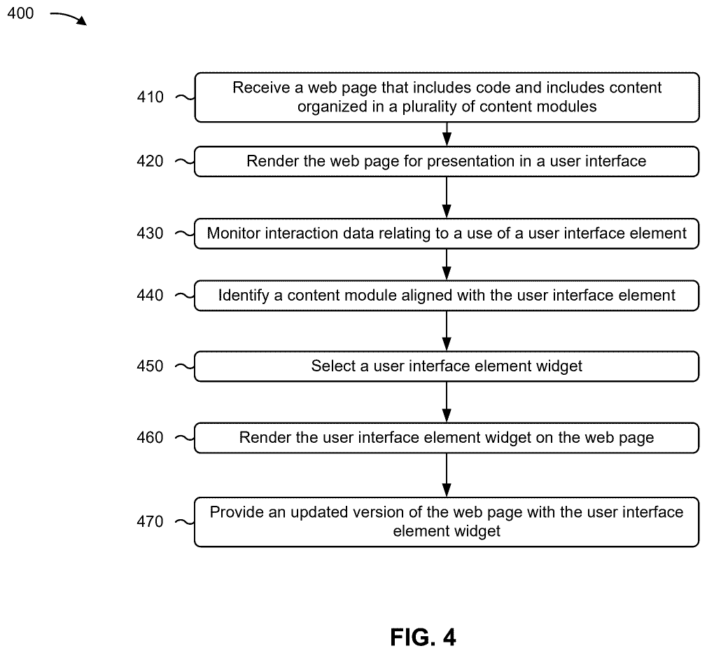

FIG. 4 is a flowchart of an example process 400 associated with content delivery of contextual information via user interface elements. In some implementations, one or more process blocks of FIG. 4 may be performed by the user device 210. In some implementations, one or more process blocks of FIG. 4 may be performed by another device or a group of devices separate from or including the user device 210, such as the content server 220. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving a web page that includes code, and includes content organized in a plurality of content modules associated with the web page (block 410). For example, the user device 210 (e.g., using processor 320, memory 330, input component 340, and/or communication component 360) may receive a web page that includes code, and includes content organized in a plurality of content modules associated with the web page, as described above in connection with reference number 110 of FIG. 1A. As an example, the user device 210 may receive a web page, identifying information relating to a set of cars that are for sale, from the content server 220.

As further shown in FIG. 4, process 400 may include rendering the web page for presentation in a user interface (block 420). For example, the user device 210 (e.g., using processor 320 and/or memory 330) may render the web page for presentation in a user interface, as described above in connection with reference number 115 of FIG. 1A. As an example, the user device 210 may provide an initial page load of the web page for display with the information identifying the set of cars that are for sale. In some implementations, the user interface includes a user interface element associated with navigation of the web page. For example, the user interface may include a scroll bar for scrolling the web page to view information relating to the set of cars that are for sale.

As further shown in FIG. 4, process 400 may include monitoring interaction data relating to a use of the user interface element (block 430). For example, the user device 210 (e.g., using processor 320 and/or memory 330) may monitor interaction data relating to a use of the user interface element, as described above in connection with reference number 120 of FIG. 1B. As an example, the user device 210 may detect a user navigating within the web page to view other parts of the web page. In some implementations, the interaction data relates to a scrolling behavior or a user behavior. For example, the user device 210 may detect the user scrolling a scroll bar (e.g., moving the scroll bar up or down) to view other parts of the web page. In some implementations, the interaction data relates to a position of the user interface element relative to the plurality of content modules. For example, the user device 210 may capture interaction data identifying where the scroll bar is within a display and what information of the web page is aligned to the scroll bar within a viewport capture or focus capture associated with the scroll bar.

As further shown in FIG. 4, process 400 may include identifying a content module aligned with the user interface element (block 440). For example, the user device 210 (e.g., using processor 320 and/or memory 330) may identify in accordance with the interaction data, a content module, of the plurality of content modules, aligned with the user interface element, as described above in connection with reference number 125 of FIG. 1B. As an example, the user device 210 may determine a subset of information provided on the web page that is aligned to a position of a scroll bar within a display of the user device 210. In this example, the subset of information may include information identifying a particular car for sale of the set of cars listed for sale on the web page.

As further shown in FIG. 4, process 400 may include selecting a user interface element widget (block 450). For example, the user device 210 (e.g., using processor 320 and/or memory 330) may select, responsive to identification of the content module, a user interface element widget, as described above in connection with reference number 145 of FIGS. 1C and 1D. As an example, based on determining that the scroll bar is aligned to a particular car that is listed for sale on the web page, the user device 210 may select a calculator widget to provide financing information regarding the particular car. Additionally, or alternatively, the user device 210 may provide a scheduling widget, a contact widget, or another type of user interface element widget.

As further shown in FIG. 4, process 400 may include rendering the user interface element widget on the web page (block 460). For example, the user device 210 (e.g., using processor 320 and/or memory 330) may render the user interface element widget on the web page, as described above in connection with reference number 150 of FIGS. 1C and 1D. As an example, the user device 210 may update a view of the web page to include the user interface element widget. In this example, the user device 210 may change a shape, color, size, or set of elements within the scroll bar to expand the user interface element widget.

As further shown in FIG. 4, process 400 may include providing an updated version of the web page with the user interface element widget (block 470). For example, the user device 210 (e.g., using processor 320 and/or memory 330) may provide an updated version of the web page with the user interface element widget, as described above in connection with reference number 155 of FIGS. 1C and 1D. As an example, the user device 210 may provide contextual information about the particular car, for sale on the web page and aligned to the scroll bar, via the user interface element widget, such as showing financing calculations within a calculator widget.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for providing contextual information via a user interface element, the system comprising:
one or more memories; and
one or more processors, communicatively coupled to the one or more memories, configured to:
receive a web page that includes code, and includes content organized in a plurality of content modules associated with the web page;
render, in connection with an initial page load, the web page for presentation in a user interface,
wherein the user interface includes a user interface element associated with navigation of the web page;
monitor interaction data relating to a use of the user interface element,
wherein the interaction data relates to a scrolling behavior,
wherein the interaction data relates to a position of the user interface element relative to the plurality of content modules;
identify, in accordance with the interaction data, a content module, of the plurality of content modules, aligned with the user interface element;
generate, responsive to identification of the content module, contextual information for the user interface element;
render the contextual information in connection with the user interface element, such that the user interface element is transformed from an initial version of the user interface element to a target version of the user interface element; and
provide the target version of the user interface element with the web page.

2. The system of claim 1, wherein the user interface element is a scroll bar.

3. The system of claim 1, wherein the content module is within a focus capture window associated with the user interface element.

4. The system of claim 1, wherein the one or more processors, when configured to generate the contextual information, are configured to:
determine a type of information included in the content module;
identify a user interface element widget corresponding to the type of information included in the content module; and
generate the contextual information for the user interface element widget.

5. The system of claim 4, wherein the target version of the user interface element includes the user interface element widget being provided for display.

6. The system of claim 1, wherein the one or more processors, when configured to generate the contextual information, are configured to:
extract content information from the content module;
insert the content information into a user interface element widget, such that a calculation is performed; and
generate the contextual information for the user interface element widget based on a result of the calculation.

7. The system of claim 1, wherein the one or more processors, when configured to generate the contextual information, are configured to:
obtain a set of user preferences relating to the contextual information; and
generate the contextual information based on the set of user preferences.

8. A method, comprising:
receiving, by a device, a web page that includes code, and includes content organized in a plurality of content modules associated with the web page;
rendering, by the device and in connection with an initial page load, the web page for presentation in a user interface,
wherein the user interface includes a user interface element associated with navigation of the web page;
monitoring, by the device, interaction data relating to a use of the user interface element,
wherein the interaction data relates to a scrolling behavior,
wherein the interaction data relates to a position of the user interface element relative to the plurality of content modules;
identifying, by the device, in accordance with the interaction data, a content module, of the plurality of content modules, aligned with the user interface element;
selecting, by the device and responsive to identification of the content module, a user interface element widget;
rendering, by the device, the user interface element widget on the web page; and
providing, by the device, an updated version of the web page with the user interface element widget.

9. The method of claim 8, wherein the user interface element widget is a calculator widget.

10. The method of claim 9, wherein the calculator widget includes one or more fields that are pre-filled, for a user, with information from the content module.

11. The method of claim 8, wherein the user interface element is an alert widget.

12. The method of claim 11, wherein the alert widget includes a notification with information from the content module.

13. The method of claim 8, wherein rendering the user interface element widget comprises:
extracting content information from the content module;
inserting the content information into a user interface element widget, such that a calculation is performed; and
providing, via the user interface element widget, a result of the calculation.

14. The method of claim 8, wherein rendering the user interface element widget comprises:
analyzing a user behavior based on the interaction data;
generating a recommendation for the user interface element widget based on the user behavior; and
generating the user interface element widget based on the recommendation.

15. A non-transitory computer-readable medium storing a set of instructions, the set of instructions comprising:
one or more instructions that, when executed by one or more processors of a system, cause the system to:
receive a web page that includes code, and includes content organized in a plurality of content modules associated with the web page;
render, in connection with an initial page load, the web page for presentation in a user interface,
wherein the user interface includes a scroll bar associated with navigation of the web page;
monitor interaction data relating to a use of the scroll bar
wherein the interaction data relates to a position of the scroll bar relative to the plurality of content modules;
identify, in accordance with the interaction data, a content module, of the plurality of content modules, aligned with the scroll bar;
insert, responsive to identification of the content module, contextual information from the content module into a scroll bar widget provided at least partially within the scroll bar; and
provide an updated version of the web page with the contextual information inserted into the scroll bar widget.

16. The non-transitory computer-readable medium of claim 15, wherein the content module is within a focus capture window associated with the scroll bar.

17. The non-transitory computer-readable medium of claim 15, wherein the one or more instructions, that cause the system to insert the contextual information, cause the system to:
determine a type of information included in the content module;
identify a type of the scroll bar widget corresponding to the type of information included in the content module; and
generate the contextual information for the scroll bar widget.

18. The non-transitory computer-readable medium of claim 15, wherein the one or more instructions, that cause the system to insert the contextual information, cause the system to:
extract content information from the content module;
insert the content information into a scroll bar widget, such that a calculation is performed; and
generate the contextual information for the scroll bar widget based on a result of the calculation.

19. The non-transitory computer-readable medium of claim 15, wherein the one or more instructions, that cause the system to insert the contextual information, cause the system to:
obtain a set of user preferences relating to the contextual information; and
generate the contextual information based on the set of user preferences.

20. The non-transitory computer-readable medium of claim 15, wherein the one or more instructions, that cause the system to insert the contextual information, cause the system to:
analyze a user behavior based on the interaction data;
generate a recommendation for the contextual information based on the user behavior; and
generate the contextual information based on the recommendation.
